(19) United States
(12) Patent Application Publication
(10) Pub. No.: US 2017/0217030 A1
(43) Pub. Date: Aug. 3, 2017

(54) ROTARY ELECTRIC SHAVER AND METHOD OF MANUFACTURING OUTER BLADE OF ROTARY ELECTRIC SHAVER

(71) Applicant: IZUMI PRODUCTS COMPANY, Matsumoto-shi (JP)

(72) Inventor: Yoshiyuki MIMURA, Matsumoto-shi (JP)

(73) Assignee: IZUMI PRODUCTS COMPANY, Matsumoto-shi (JP)

(21) Appl. No.: 15/394,226

(22) Filed: Dec. 29, 2016

(30) Foreign Application Priority Data
Feb. 2, 2016 (JP) 2016-017651
Oct. 28, 2016 (JP) 2016-211788

(51) Int. Cl. B26B 19/14; B26B 19/38

(52) U.S. Cl. CPC B26B 19/143; B26B 19/3893

(57) ABSTRACT

A rotary electric shaver of the present invention includes: an outer blade having an annular shaving surface provided with multiple hair inlets formed therein on an upper surface thereof; and an inner blade having a small blade which rotates in sliding contact with a lower surface of the outer blade, in which the outer blade has an integral structure using a resin material, and has a rib portion which is located between adjacent hair inlets.

### CROSS-REFERENCE TO RELATED APPLICATION

This application is based upon and claims the benefit of priority of the prior Japanese Patent Application Nos. P2016-017651, filed on Feb. 2, 2016, and P2016-211788, filed on Oct. 28, 2016, and the entire contents of which are incorporated herein by reference.

### TECHNICAL FIELD

The present invention relates to a rotary electric shaver and a method of manufacturing an outer blade of a rotary electric shaver.

### BACKGROUND ART

In the related art, a rotary electric shaver is known which cuts hair entering multiple hair inlets while including an outer blade having an annular shaving surface provided with the multiple hair inlets formed therein on an upper surface thereof and an inner blade having a small blade which rotates in sliding contact with a lower surface of the outer blade (refer to PTL 1: JP-A-2012-100729 1 and PTL 2: JP-A-2014-113204). In this invention, examples of the hair include beards, mustaches, whiskers, and the like.

### SUMMARY OF INVENTION

### Technical Problem

However, according to the rotary electric shaver in the related art as disclosed in PTLs 1 and 2, the outer blade is formed by press work or the like using a thin flat plate material made of stainless steel alloy, thereby causing a problem in that varying a configuration (structure, design, texture, and the like) of an annular shaving surface (specifically, hair inlets, rib portions, and the like) is impossible or difficult. In addition, an outer blade assembly is formed by combining the outer blade and other resin components, thereby causing a problem in that manufacturing costs such as component costs and assembly costs may increase.

### Solution to Problem

The present invention is made in view of the above-described circumstances, and an object thereof is to provide a rotary electric shaver and a method of manufacturing an outer blade of the rotary electric shaver, which can realize structures, designs, and textures which have been impossible or difficult to achieve with an outer blade formed of a metal material of the related art, and which can decrease manufacturing costs by employing an outer blade formed by injection molding or compression molding using a resin material.

The present invention solves the problems described above by solving means as disclosed below.

A rotary electric shaver disclosed herein includes an outer blade having an annular shaving surface provided with multiple hair inlets formed therein on an upper surface thereof and an inner blade having a small blade which rotates while coming into sliding contact with a lower surface of the outer blade from below the annular shaving surface. The outer blade has an integral structure using a resin material, and has a rib portion which is located between the hair inlets adjacent to each other.

According to this configuration, the outer blade is formed into an integral structure having the outer blade of a required shape achieved by injection molding or compression molding using a resin material. In other words, a blade surface is formed at a moment when the outer blade is molded, and thus a post process such as those required in the related art is no longer necessary. Therefore, a step of forming the outer blade can be greatly simplified compared with the related art. Consequently, all of component cost, apparatus cost, and assembly cost can be greatly decreased. In addition, structures, designs, and textures, which have been impossible or difficult to achieve with the outer blade formed of a metal material of the related art, can be realized. Furthermore, deformation due to release of residual stress and a problem of metallic allergy of users, which have been pending matters in a case where a metallic material is used, can be solved.

Preferably, the outer blade includes multiple types of rib portions different in height position of an upper surface thereof as the rib portion.

According to this configuration, a configuration in which relatively thick rib portions and relatively thin rib portions are complexly disposed is achieved, thereby enabling deep shaving while restraining damage to skin.

Preferably, the outer blade includes the rib portion having an upper surface formed into one of convex, concave, and waving shapes along a radial direction.

According to this configuration, an outer blade which meets an intended effect such as achievement of an effect of achieving improved feeling, and achievement of an effect of enhancing deep shaving performance, achievement of an effect of easy catching of unruly hair, can be realized.

Preferably, the outer blade includes the rib portion having the upper surface formed into a curved shape at both end portions in a circumferential direction.

According to this configuration, the annular shaving surface can be prevented from being caught by the skin when the outer blade is slid along the skin, and improved feel is achieved owing to a contact with the curve.

Preferably, the outer blade includes the rib portion having a lower surface, the lower surface includes a rear side in a rotation direction of the inner blade and a front side in the rotation direction of the inner blade, and the rear side is formed at a relatively low position that comes into sliding contact with the inner blade and a front side of the inner blade in the rotation direction is formed at a relatively high position that does not come into sliding contact with the inner blade.

According to this configuration, a surface area of the sliding contact between the inner blade and the outer blade (the lower surface of the rib portion) can be decreased. Therefore, a frictional resistance decreases, and thus both of power consumption and noise (siding noise) can be reduced.

Preferably, the outer blade includes the annular shaving surface having an embossed front surface.

According to this configuration, a surface area of the outer blade (annular shaving surface) that comes into contact with the skin is reduced and thus sliding resistance is lowered. Therefore, when moving the outer blade so as to slide along the skin, the outer blade slides smoothly, so that a user can get a smooth feeling of use.

Preferably, the resin material is a material having transparency or translucency, or a material containing colorant that gives a color thereto.

According to this configuration, designs and textures, which cannot be achieved by the outer blade formed of the metal material of the related art, can be realized.

Preferably, the outer blade includes a fixing portion formed at a center position of the lower surface in the radial direction in an integral structure, and the fixing portion fixes the inner blade so as to be movable in an axial direction and immovable in the radial direction.

According to this configuration, only a single component is required for the outer blade assembly, and thus a process of assembling multiple components and an assembly device required therefor can also be eliminated. Therefore, it is possible to greatly decrease component costs, apparatus costs, and manufacturing costs.

A method of manufacturing an outer blade of the disclosed rotary electric shaver is a method of manufacturing the outer blade of a rotary electric shaver including an outer blade having an annular shaving surface provided with multiple hair inlets formed therein on an upper surface thereof, and an inner blade having a small blade which rotates in sliding contact with a lower surface of the outer blade from below the annular shaving surface, the manufacturing method including: a step of forming the outer blade by injection molding or compression molding using a resin material into an integral structure.

According to this configuration, the outer blade having an integral structure of a required shape can be formed by injection molding or compression molding using the resin material. In other words, a blade surface is formed at a moment when the outer blade is molded, and thus a post process such as those required in the related art is no longer necessary. Therefore, a step of forming the outer blade can be greatly simplified compared with the related art. Consequently, all of component cost, apparatus cost, and assembly cost can be greatly decreased. In addition, structures, designs, and textures, which have been impossible or difficult to achieve with the outer blade formed of a metal material of the related art, can be realized. Furthermore, deformation due to release of residual stress and a problem of metallic allergy of users, which have been pending matters in a case where a metallic material is used, can be solved.

### Advantageous Effects of Invention

According to the present invention, with the outer blade formed by injection molding or compression molding using the resin material, structures, designs, and textures, which have been impossible or difficult to achieve by the outer blade formed of the metal material of the related art, can be realized. In addition, reduction in manufacturing costs of the outer blade is achieved.

### BRIEF DESCRIPTION OF DRAWINGS

FIG. 1 is a schematic view (perspective view) illustrating an example of a rotary electric shaver according to an embodiment of the present invention.

FIG. 2 is a schematic view (exploded perspective view) illustrating an example of a head unit of the rotary electric shaver illustrated in FIG. 1.

FIG. 3 is a schematic view (side sectional view) illustrating an example of a blade unit of the rotary electric shaver illustrated in FIG. 1.

FIG. 4 is a schematic view (upper surface side perspective view) illustrating an example of an inner blade assembly of the rotary electric shaver illustrated in FIG. 1.

FIG. 5 is a schematic view illustrating parts of a small blade of an inner blade and an outer blade of the rotary electric shaver illustrated in FIG. 1.

FIG. 6 is a schematic view (upper surface side perspective view) illustrating an example of the outer blade of the rotary electric shaver illustrated in FIG. 1.

FIG. 7 is a schematic view (plan view) of the outer blade illustrated in FIG. 6.

FIG. 8 is a sectional view taken along the line VIII-VIII in FIG. 7.

FIG. 9 is a schematic view illustrating an example of an outer blade of a rotary electric shaver according to an embodiment of the related art.

FIG. 10 is a schematic view (lower surface side perspective view) illustrating an example of an outer blade cover of the rotary electric shaver illustrated in FIG. 1.

FIG. 11 is a sectional view taken along the line XI-XI in FIG. 7.

FIG. 12 is a schematic view illustrating an example of an outer blade of the rotary electric shaver according to the embodiment of the related art.

FIG. 13 is an enlarged view of the portion XIII in FIG. 8.

FIG. 14 is a modification of a configuration illustrated in FIG. 13.

FIG. 15 is a modification of the configuration illustrated in FIG. 13.

FIG. 16 is a modification of the configuration illustrated in FIG. 13.

FIG. 17 is an enlarged view of the portion XVII in FIG. 11.

FIG. 18 is a modification of the configuration illustrated in FIG. 17.

FIG. 19 is a modification of the configuration illustrated in FIG. 11.

FIG. 20 is a modification of the configuration illustrated in FIG. 11.

FIG. 21 is a schematic view illustrating an example of embossing applied to the outer blade of the rotary electric shaver illustrated in FIG. 1.

FIG. 22 is an explanatory drawing illustrating a configuration example of a case where annular shaving surfaces of the outer blade of the rotary electric shaver illustrated in FIG. 1 have multiple colors.

FIG. 23 is an explanatory drawing illustrating another configuration example of a case where the annular shaving surfaces of the outer blade of the rotary electric shaver illustrated in FIG. 1 have multiple colors.

FIG. 24 is a schematic view (upper surface side perspective view) illustrating another example of the outer blade of the rotary electric shaver illustrated in FIG. 1.

FIG. 25 is a schematic view (lower surface side perspective view) of the outer blade illustrated in FIG. 23.

### DESCRIPTION OF EMBODIMENTS

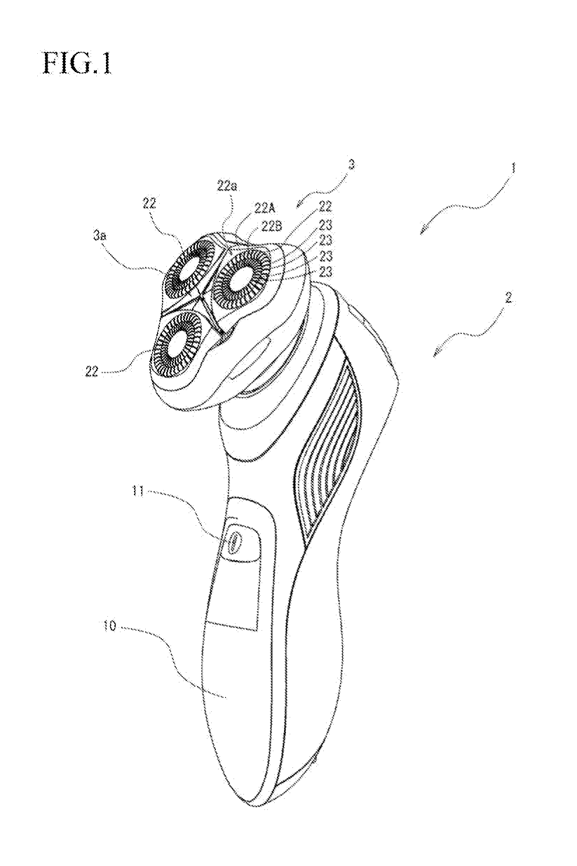

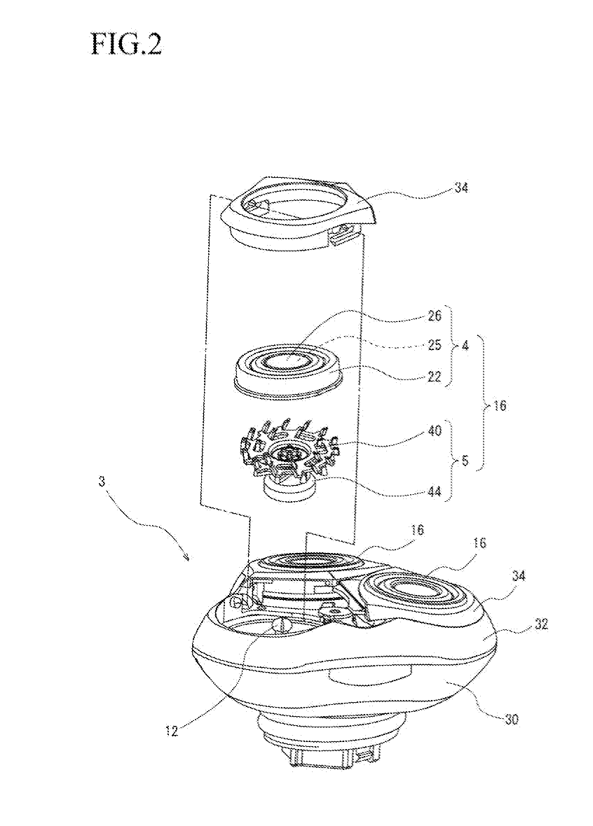

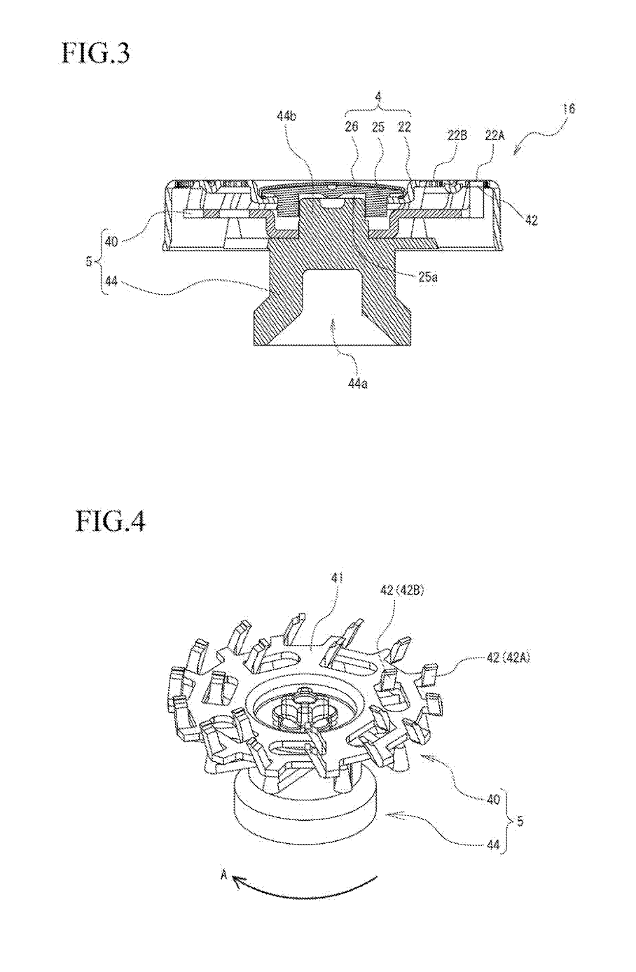

Referring to the drawings, an embodiment of the present invention will be described below in detail. FIG. 1 is a perspective view (schematic view) illustrating an example of a rotary electric shaver 1 according to the embodiment of the present invention. In addition, FIG. 2 is an exploded perspective view (schematic view) illustrating a head unit 3 of the rotary electric shaver 1. FIG. 3 is a side sectional view (schematic view) illustrating a blade unit 16. In all drawings used in describing the embodiments, the same reference numerals will be given to members having the same function, and repeated description thereof will be omitted in some cases.

The rotary electric shaver 1 according to the embodiment is a rotary electric shaver configured such that the head unit 3 held in a main body 2 includes an outer blade 22 having multiple hair inlets 23 formed therethrough and an inner blade 40 that rotates in sliding contact with a lower surface of the outer blade 22, and configured to cut hair entering the hair inlets 23 with the outer blade 22 and the inner blade 40 as illustrated in FIG. 1 to FIG. 3. A rotary electric shaver having three sets of the blade units 16 including the outer blade 22 and the inner blade 40 will be described as an example. However, the number of sets of the blade units 16 is not limited thereto, and may be one set or other multiple number of sets (not illustrated). In addition, a configuration may be adopted so that the outer blade is also rotatably driven together with the inner blade (not illustrated).

The main body 2 includes a substantially cylindrical case 10. A drive source (as an example, a motor), a battery, and a control circuit board (all not illustrated) are accommodated inside the case 10. In addition, a power switch 11 is attached to a front surface of the case 10.

The head unit 3 illustrated in FIG. 2 includes a head case 30 which is held by being connected to an upper portion of the case 10 in the main body 2, an outer blade frame 32 which is fitted to the head case 30 from above, an inner blade drive shaft 12 which is accommodated in an inner bottom portion of the head case 30, and three sets of the blade units 16 which are held in the outer blade frame 32 so as to be slightly and vertically movable and swingable. As an example, three sets of the blade units 16 are disposed so as to form a triangle in a plan view.

In addition, each blade unit 16 is assembled by fitting an inner blade assembly 5 provided with the inner blade 40 and an outer blade assembly 4 provided with the outer blade 22 to each other, and in this state, fitting an outer blade case 34 thereto from above, and then is fixed to (held in) the outer blade frame 32 so as to be swingable and vertically movable. In this case, the upper end (spherical portion) of the inner blade drive shaft 12 engages with a lower portion of an inner blade base 44 from below, and the inner blade assembly 5 is rotatably driven by driving the inner blade drive shaft 12.

In addition, in the present embodiment, the respective outer blade cases 34 are configured to be respectively swingable with respect to the outer blade frame 32 in a seesaw-like manner while both of these are interlocked to each other. In this manner, an upper surface 3a of the head unit 3 is deformable between a convex state and a concave state.

In the present embodiment, the case where three sets of the blade units 16 are provided is exemplified as described above. However, a basic configuration may be similarly conceivable even in a case where blade units are included in an alternative combination other than three sets.

The outer blade 22 has a configuration in which multiple holes 23 which function as the hair inlets are formed therethrough in an axial direction (that is, the same direction as an axial direction of a rotary shaft of the inner blade), and the inner blade 40 cuts hair that enters the hair inlets 23. In other words, the outer blade 22 has a configuration such that an upper surface 22a corresponds to a shaving surface which comes into contact with a user's skin, and the hair inlets 23 open from the upper surface 22a. The upper surface 22a is formed into an annular flat surface, that is, into the annular shaving surface. As an example, the outer blade has a so-called dual track configuration in which the annular shaving surfaces are disposed in two rows on a circumference close to an outer periphery and on a circumference close to an inner periphery (reference numerals 22A and 22B in the drawing). However, without being limited thereto, other configurations such as a triple track configuration in which the annular shaving surfaces are disposed in three rows may be employed (not illustrated). Detailed description about the outer blade 22 will be given later.

On the other hand, the inner blade 40 constitutes the inner blade assembly 5 by being fixed to the inner blade base 44. The inner blade base 44 is provided on a lower portion thereof with a concave portion 44a to which the upper end of the inner blade drive shaft 12, which is coupled to an output shaft of a motor, is fitted. As a modification, a configuration in which a rotor driven by the inner blade drive shaft 12 includes a single component, that is, only an inner blade without being provided with the inner blade base, is also conceivable (not illustrated).

As illustrated in FIG. 4, the inner blade 40 according to the present embodiment is configured to include multiple small blades 42 in which an inner blade base plate 41 having a substantially disc-shaped flat plate is partially erected from a plate surface (in order to simplify the drawings, the reference numerals are given to only a few of the small blades). As an example, as illustrated in FIG. 5, the small blade 42 is formed so that a front end surface 42b tilts forward in the rotation direction. Therefore, a front side upper end edge in the rotation direction functions as a blade edge 42a. The rotation direction of the inner blade 40 is indicated by an arrow A.

The small blade 42 according to the present embodiment is formed so that the width in the radial direction is constant from an upper end to a lower end. As an example, the small blade 42 has a substantially prismatic shape having a rectangular section in which the width in the radial direction is approximately 1 mm and the width in the circumferential direction is approximately 0.5 mm The small blade 42 is formed so that the length (length from the base to the blade edge) is approximately 3 mm. However, the dimensional shape is not limited thereto.

In the present embodiment, the inner blade has a so-called dual track configuration in which the small blades 42 are disposed in two rows on a circumference close to an outer periphery and on a circumference close to an inner periphery corresponding to the outer blade 22 described above (reference numerals 42A and 42B in the drawing). However, without being limited thereto, other configurations corresponding to the configuration of the outer blade 22 (for example, triple track configuration) are conceivable (not illustrated).

With the blade unit 16 assembled with the configuration described thus far, a state in which the small blades 42 of the inner blade 40 come into abutment with the lower surface 22b of the outer blade 22 is achieved (see FIG. 3 and FIG. 5). With the inner blade 40 rotatably driven in the direction indicated by the arrow A in this state, hair X entering the hair inlets 23 can be cut by the blade edges 42a of the inner blade 40 (small blade 42).

A configuration of the outer blade 22 characterized by the present embodiment will be described in detail with reference to the drawings.

### FIRST EXAMPLE

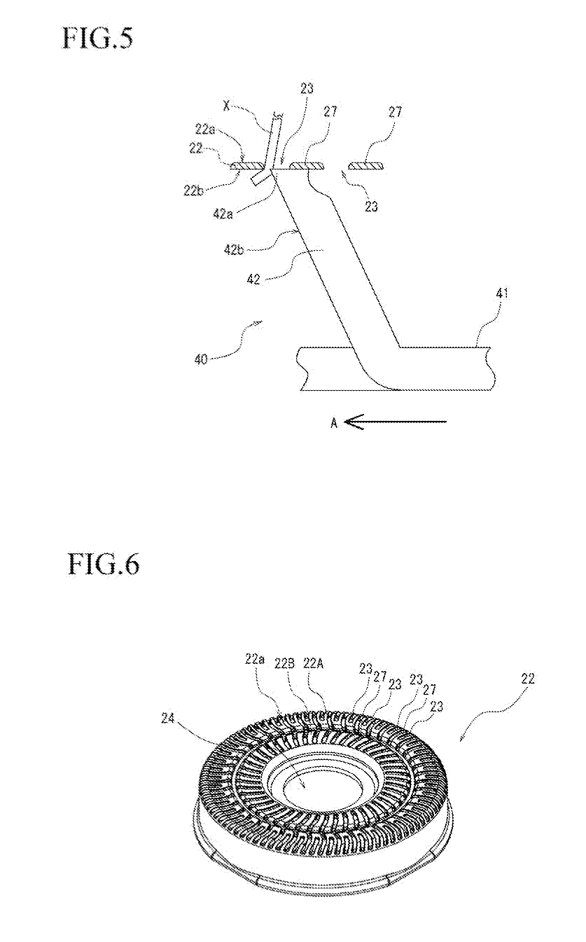

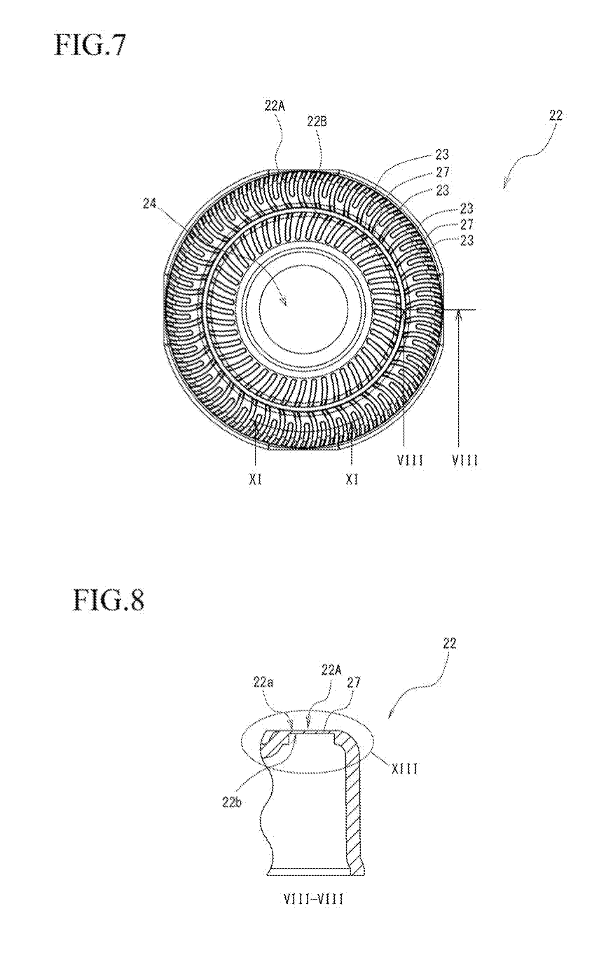

A first example of the outer blade 22 is illustrated in FIG. 6 and FIG. 7. Here, FIG. 6 is an upper surface side perspective view (schematic view) of the outer blade 22. FIG. 7 is a plan view (schematic view) thereof.

In the first example, the outer blade 22 is characterized by being formed as an integral structure using a resin material. As an example, the outer blade 22 is formed by injection molding or compression molding by using an engineering plastic material having a Rockwell Hardness HRC 40-60.

The outer blade 22 has a substantially cup shape having a peripheral edge bent downward. In addition, a number of the hair inlets 23 are formed on the upper surface 22a (that is, penetrating therethrough from the upper surface 22a to the lower surface 22b). In this manner, an operation for cutting the hair entering the hair inlets 23 can be performed by interposing the hair between a lower end portion of the hair inlets 23 and the inner blade 40 (small blade 42).

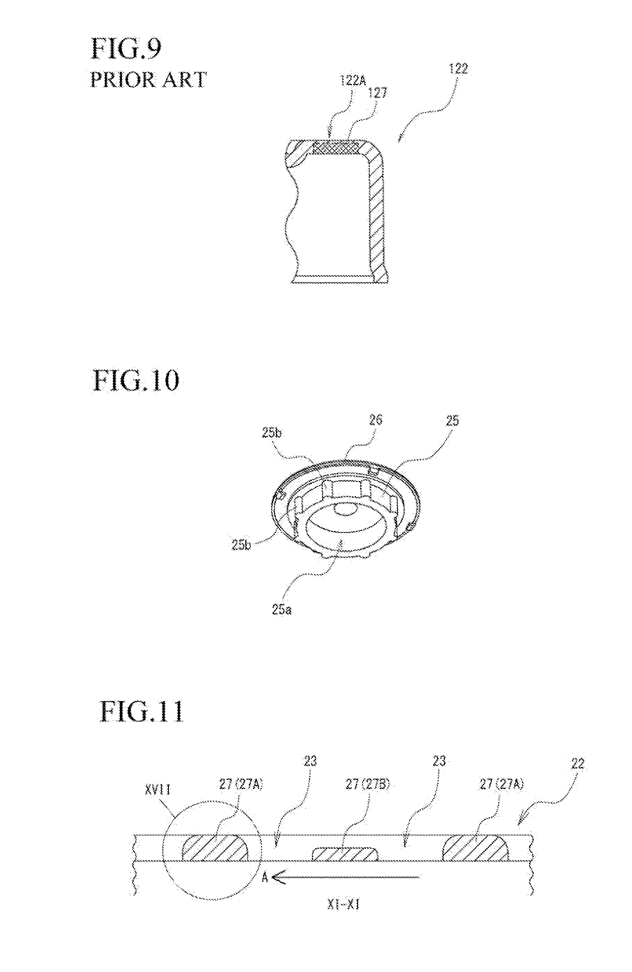

Here, FIG. 8 is a sectional view of the outer blade 22 (sectional view taken along the line VIII-VIII in FIG. 7). In contrast, FIG. 9 shows a sectional view of the equivalent position of an outer blade 122 of the related art formed by using a metal material as a reference drawing (Reference numeral 122A denotes an annular shaving surface, and reference numeral 127 denotes a rib portion). As an example, the method of manufacturing the outer blade 122 of the related art illustrated in FIG. 9 includes a step of preparing a thin flat plate material made of stainless steel alloy, press-punching the front surface side of the plate material through press work (shearing press work) so as to form a substantially disc-shaped member having a predetermined shape, and performing a punching process at a predetermined position. Next, press work (drawing press work) is carried out for the substantially disc-shaped member which has subjected to press-punching so as to assume a substantially cup shape. Next, a quenching step (hardening step by heat) is carried out, then a step of forming slit-shaped hair inlets by grinding process using a rotary disc-shaped grind stone at a predetermined position of the annular shaving surface is carried out. Next, a thinning step is carried out by a cutting work or a polishing work for removing a blade surface portion (a cross-hatched portion in FIG. 9) of a back surface of the annular shaving surface, with which the small blade comes into sliding contact. The reason why the thinning step is required is that the blade surface portion cannot achieve deep shaving unless otherwise thinned. Finally, a surface finishing step (polishing step and the like) is carried out to achieve completion of the outer blade.

In contrast, the method of manufacturing the outer blade 22 according to the first example is configured to form an integral structure having a required shape by injection molding or compression molding by using a resin material. Therefore, the blade surface is formed at a moment when the outer blade 22 is molded, and thus a post process required in the related art is no longer necessary. More specifically, processing steps such as grinding with the rotary disc-shaped grind stone, working step such as ECM, and pressing for forming the slit-shaped hair inlets do not have to be provided. In addition, the quenching step for hardening the metal material by heat does not have to be provided. Moreover, the blade surface thinning step by cutting work or polishing work does not have to be provided. In the thinning step of the related art, deformation due to release of residual stress after execution of the step has been an issue. However, such a problem does not occur. In this manner, an outer blade forming step can be greatly simplified compared with the related art.

Furthermore, the hair inlets 23 can employ various shapes such as a radially slit shape, a round hole shape, or a combination thereof. In particular, the outer blade 22 of the first example is formed into a required shape by injection molding or compression molding using the resin material. Therefore, a hair inlet shape, which is impossible to form by the method based of works such as grinding, ECM, or pressing like the outer blade of the related art using a metal material can be realized. More specifically, complex curved shapes such as wavy lines which cannot be formed by the grinding process, and a shape having narrow slit intervals or a shape having small opening surface areas, which cannot be formed by the press work can be realized.

The outer blade formed by using the metal material of the related art might cause metallic allergy depending on the user. However, such a problem can be solved by using the outer blade formed of the resin material as in the first example.

In the first example, a fitting hole 24 is provided at a center of the outer blade 22 in the radial direction, and an outer blade cover 25 is fixed to the fitting hole 24 to constitute the outer blade assembly 4. However, as illustrated in a seventh example described later, an outer blade assembly including a single component, that is, only the outer blade 22 is also conceivable by employing an integral structure including also a shape which corresponds to the outer blade cover as described in a seventh example described later.

Here, as illustrated in FIG. 10, the outer blade cover 25 is formed in a substantially cup shape by using a resin material, and a lower portion thereof is provided with the cylindrical portion 25a which a convex portion 44b of the inner blade base 44 engages. In addition, multiple projection portions 25b are disposed on an outer wall portion of the cylindrical portion 25a. The multiple projection portions 25b are fitted and fixed by caulking to the fitting hole 24 formed at the center of the outer blade 22 in the radial direction. In this manner, in a state where the center of the outer blade 22 is aligned with the center of the outer blade cover 25 (here, the cylindrical portion 25a), both of these are fitted to each other, thereby configuring the outer blade assembly 4. A decorative plate 26 made of a metal material such as stainless steel alloy is fitted to an upper portion of the outer blade cover 25. However, a configuration may be adopted by omitting the decorative plate 26.

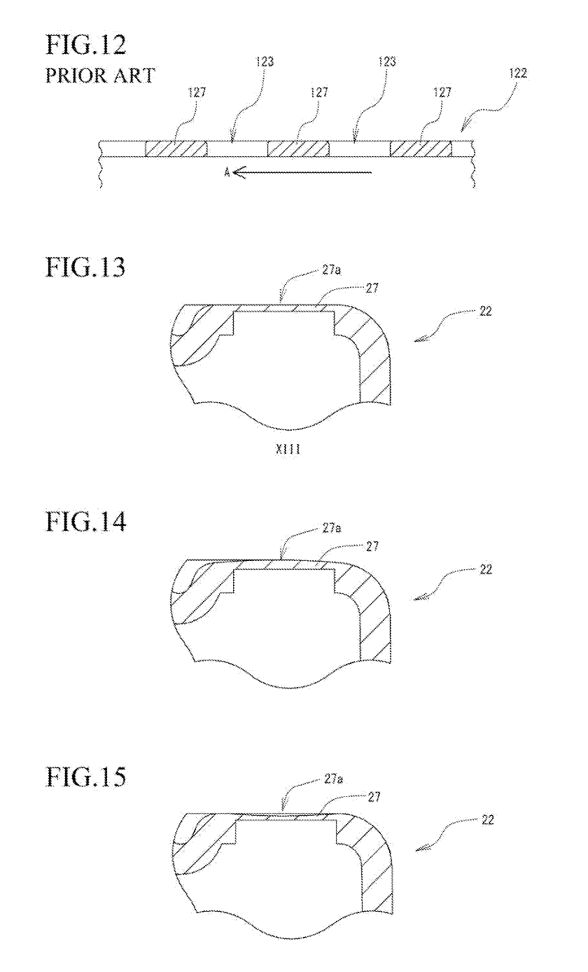

Next, FIG. 11 is a sectional view of the outer blade 22 (sectional view taken along the line XI-XI in FIG. 7). In contrast, FIG. 12 shows a sectional view of the equivalent position of the outer blade 122 of the related art formed by using a metal material as a reference drawing (reference numeral 123 denotes a hair inlet and reference numeral 127 denotes a rib portion). The outer blade 22 according to the first example includes rib portions 27 having multiple types different in height position of upper surfaces as a rib portion (portion provided between one hair inlet 23 and another hair inlet 23 adjacent thereto). Two types (27A, 27B) are exemplified as the “multiple types” in FIG. 11. However, the types are not limited thereto, and three or more types may be provided (not illustrated).

For example, by forming the rib portion 27A to be thicker than other rib portions, damage to the user's skin can be restrained. In contrast, by forming the rib portions to be thinner than other rib portions like the rib portions 27B, deep shaving performance can be enhanced. Therefore, a configuration in which relatively thick rib portions (exemplified as 27A) and relatively thin rib portions (exemplified as 27B) are complexly disposed is achieved, thereby enabling deep shaving while restraining damage to skin. As described above, the number of shapes (thicknesses) of the rib portions complexly disposed is not limited to two types.

Although setting of the height positions of the upper surfaces of the rib portions 27, that is, the size (length) in the height (vertical) direction of the rib portions 27 is not specifically limited. Preferably, however, the rib portions having the lowest height position may be preferably formed to have a size in the height direction from approximately three-tenth to approximately nine-tenth, inclusive, of the rib portions having the highest height position. Accordingly, the advantageous effects described above are obtained. More preferably, the rib portions having the lowest height position may be formed to have a size in the height direction from approximately one third to approximately two third, inclusive, of the rib portions having the highest height position. Accordingly, the advantageous effects described above, that is, both of restraint of damage to the skin and realization of deep shaving can be realized at high dimensionality.

In contrast, the outer blade 122 of the related art illustrated in FIG. 12 is formed by press work or the like with a thin flat plate material made of stainless steel alloy as described above. Therefore, the thickness of the blade is inevitably constant. In other words, it is impossible to change the height position of upper surfaces of the rib portions 127 (the length in the vertical direction) along the circumferential direction of the annular shaving surface, and the advantageous effects achieved by the first example as described above cannot be obtained. If an attempt is made to change the height positions of the upper surfaces (length in the vertical direction) of the rib portion 127 partly, complex working step (cutting, polishing, or the like) is required. Consequently, both of the number of working steps and time required for work are increased, and thus the manufacturing costs are increased correspondingly. Therefore, in view of high-volume production property of industrial products, it is impossible or difficult to achieve.

### SECOND EXAMPLE

Subsequently, the outer blade 22 of a second example will be described. The outer blade 22 according to the second example includes an integral structure using a resin material in the same manner as that in the first example described above. Other configurations may be the same as those of the first example, or may be different. Characteristic configurations of the second example will be focused in description given below.

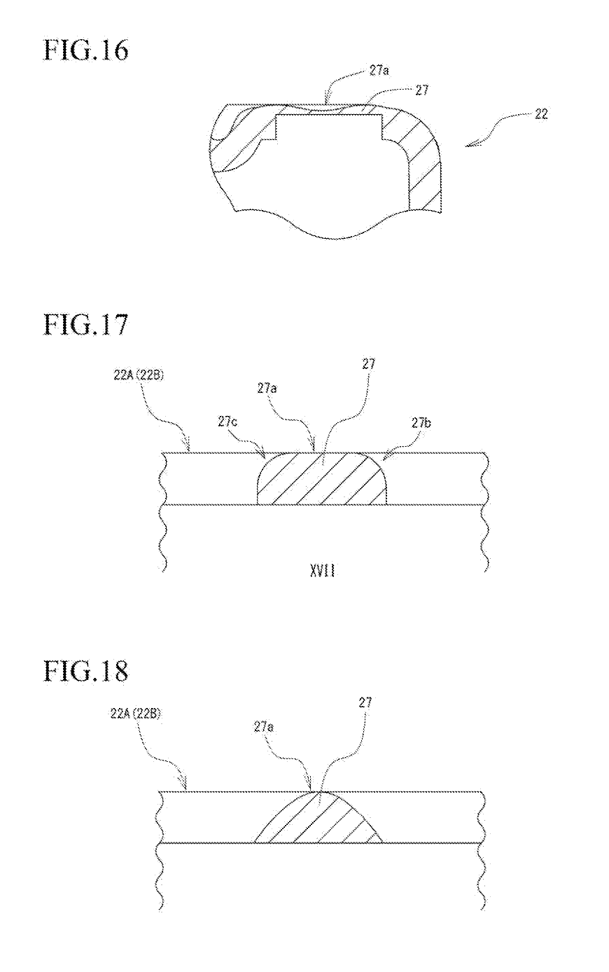

FIG. 13 is an enlarged view of the rib portion 27 of the outer blade 22 (enlarged view of a circled portion XIII in FIG. 8). As illustrated in FIG. 13, forming an upper surface into a flat shape is naturally possible in the same manner as the rib portion of the related art. Furthermore, modifications of the second example are illustrated in FIG. 14 to FIG. 16 (all of these drawings are of the equivalent position to FIG. 13). As illustrated in FIG. 14, an upper surface 27a of the rib portion 27 may be formed into a convex shape along the radial direction (in a direction connecting an inner side and an outer side in the radial direction). As illustrated in FIG. 15, the upper surface 27a of the rib portion 27 may be formed into a concave shape along the radial direction. Alternatively, as illustrated in FIG. 16, the upper surface 27a of the rib portion 27 can be formed into a wavy shape (a shape including convex shapes and concave shapes mixed regularly or irregularly like a wavy line) along the radial direction.

For example, improved feel is achieved by forming the upper surface 27a of the rib portion to be thick such as a convex shape at a position corresponding to the blade surface portion with which the small blade 42 comes in sliding contact like the rib portion 27 illustrated in FIG. 14. In contrast, deep shaving performance can be enhanced by forming the upper surface 27a of the rib portion to be thin such as a concave shape at a position corresponding to the blade surface portion with which the small blade 42 comes into sliding contact like the rib portion 27 illustrated in FIG. 15. Alternatively, an effect of enabling easy catching of unruly hair is achieved by forming the upper surface 27a of the rib portion to have a shape including the convex shape and the concave shape combined complexly at a position corresponding to the blade surface portion with which the small blade 42 comes into sliding contact into (for example, a wavy shape) as the rib portion 27 illustrated in FIG. 16.

In contrast, the outer blade 122 of the related art illustrated in FIG. 9 and FIG. 12 is formed by press work or the like with a thin flat plate material made of stainless steel alloy as described above. Therefore, the thickness of the blade is inevitably constant. In other words, it is impossible to change the upper surfaces of the rib portions 127 into a convex shape, a concave shape, or a wavy shape along the radial direction of the annular shaving surface, and the advantageous effects achieved by the second example as described above cannot be obtained. If an attempt is made to machine the upper surfaces of the rib portions 127 to be a convex shape, a concave shape, or a wavy shape along the radial direction, a special working step such as electro-discharge machining or electrolytic processing is required. Consequently, both of the number of working steps and time required for work are increased, and thus the manufacturing costs are increased correspondingly. Therefore, in view of high-volume production property of industrial products, it is impossible or difficult to achieve.

In this manner, according to the outer blade 22 of the second example, the outer blade is formed by injection molding or compression molding using a resin material. Therefore, the shapes exemplified in FIG. 14 to FIG. 16 described above, which is impossible to form by a technology of the related art, can be realized.

### THIRD EXAMPLE

Subsequently, the outer blade 22 of a third example will be described. The outer blade 22 according to the third example includes an integral structure using a resin material in the same manner as those of the first and second examples described above. Other configurations may be the same as those of the first and second examples, or may be different. Characteristic configurations of the third example will be focused in description given below.

FIG. 17 is an enlarged view of a rib portion 27 of the outer blade 22 (enlarged view of a circled portion XVII in FIG. 11). As illustrated in FIG. 17, the upper surface of the rib portion 27 has a curved shape at both end portions 27b, 27c in the circumferential direction (a direction of rotation of the inner blade 40, that is, a direction of motion line of the small blade 42), and a central portion in the circumferential direction is formed into a flat shape. As a modification, a shape in which the both end portions 27b, 27c in the circumferential direction are chamfered into a linear shape is also conceivable (not illustrated).

Alternatively, as another modification, the upper surface 27a of the rib portion 27 may be formed into a convex curved shape along the circumferential direction as illustrated in FIG. 18. The “curved shape” is not limited to a shape having a constant curvature.

In particular, by forming the shape of the upper surface 27a to have a curved shape at the both end portions 27b, 27c in the circumferential direction or to have a convex curved shape along the circumferential direction as the rib portions 27 illustrated in FIG. 17 and FIG. 18, being caught by the skin when the outer blade is slid along the skin can be prevented, and improved feel is achieved owing to a contact with the curve.

In contrast, the outer blade 122 of the related art illustrated in FIG. 9 and FIG. 12 is formed by press work or the like with a thin flat plate material made of stainless steel alloy as described above. Therefore, the both end portions of the upper surface of the rib portion 127 in the circumferential direction inevitably have a sharp apex shape. As a matter of course, the apex shape can be made gentle to some extent by carrying out the polishing work or the like in the post process. However, both of the number of working steps and the time required for work are increased and an increase in manufacturing costs may result. Even more, processing the upper surface of the rib portion to have a convex curved shape along the circumferential direction is impossible or difficult to realize in view of a processing method or the time required for work in the high-volume production property of the industrial products.

In this manner, according to the outer blade 22 of the third example, the outer blade is formed by injection molding or compression molding using a resin material. Therefore, the shapes exemplified in FIG. 17 and FIG. 18 described above, which is impossible or difficult to form by a technology in the related art, can be realized.

### FOURTH EXAMPLE

Subsequently, the outer blade 22 of a fourth example will be described. The outer blade 22 according to the fourth example includes an integral structure using a resin material in the same manner as those of the first to third examples described above. Other configurations may be the same as those of the first to third examples, or may be different. Characteristic configurations of the fourth example will be focused in description given below.

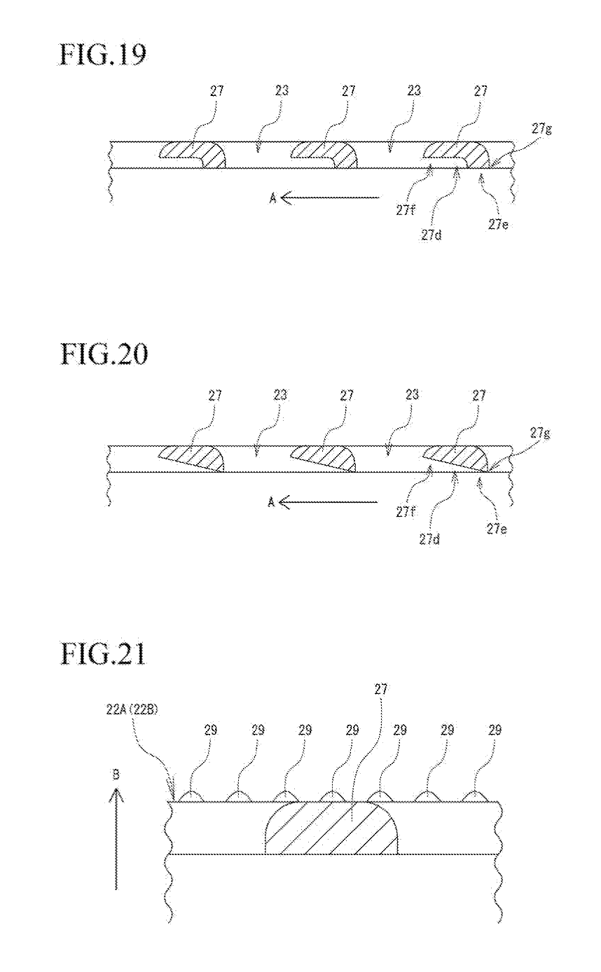

FIG. 19 is an enlarged view of the rib portion 27 of the outer blade 22 of the fourth example (a drawing of the position equivalent to FIG. 11). As illustrated in FIG. 19, a lower surface 27d of the rib portion 27 is formed in such a manner that a rear side portion 27e in the rotation direction of the inner blade 40 (direction indicated by the arrow A) is formed at a relatively low position that comes into sliding contact with the inner blade 40 (specifically, the blade edge 42a of the small blade 42), and a front side portion 27f in the rotation direction of the inner blade 40 (direction indicated by the arrow A) is formed at a relatively high position that does not come into sliding contact with the inner blade 40 (specifically, the blade edge 42a of the small blade 42). However, the configuration of the rib portion 27 is not limited to that illustrated in FIG. 19, and a configuration illustrated in FIG. 20 is also conceivable as a modification.

According to this configuration, regarding the lower surface 27d of the rib portions 27, since the rear side portion 27e in the rotation direction of the inner blade 40 (the direction indicated by the arrow A) comes into sliding contact with the blade edge 42a of the small blade 42, hair entering the hair inlets 23 can be cut by being interposed between a rear side lower end portion 27g of the rib portions 27 and the blade edge 42a of the small blade 42 in the same manner as the related art. In contrast, since a front side portion 27f in the rotation direction of the inner blade 40 (direction indicated by the arrow A) does not come into sliding contact with the blade edge 42a of the small blade 42, a surface area that comes into sliding contact with the inner blade 40 can be reduced compared with the configuration of the rib portion 127 of the related art illustrated in FIG. 12. Therefore, a frictional resistance decreases, and thus both of power consumption and noise (siding noise) can be reduced.

In contrast, the outer blade 122 of the related art illustrated in FIG. 9 and FIG. 12 is formed by press work or the like with a thin flat plate material made of stainless steel alloy as described above. Therefore, the thickness of the blade is inevitably constant. In other words, it is impossible to change the height position of the lower surface of the rib portion 127 between the rear side and the front side (position in the vertical direction) along the circumferential direction of the annular shaving surface, and the advantageous effects achieved by the fourth example as described above cannot be obtained. If an attempt is made to machine the lower surface of the rib portion to change the height between the rear side and the front side along the circumferential direction, a special working step such as electro-discharge machining, or electrolytic processing is required. Consequently, both of the number of working steps and time required for work are increased, and thus the manufacturing costs are increased correspondingly. Therefore, in view of high-volume production property of industrial products, it is impossible or difficult to achieve.

In this manner, according to the outer blade 22 of the fourth example, the outer blade is formed by injection molding or compression molding using a resin material. Therefore, the shapes exemplified in FIG. 19 and FIG. 20 described above, which is impossible to form by a technology in the related art, can be realized.

### FIFTH EXAMPLE

Subsequently, the outer blade 22 of a fifth example will be described. The outer blade 22 according to the fifth example includes an integral structure using a resin material in the same manner as those of the first to fourth examples described above. Other configurations may be the same as those of the first to fourth examples, or may be different. Characteristic configurations of the fifth example will be focused in description given below.

The outer blade 22 of the fifth example has an embossed surface on a front surface of the annular shaving surface. In general, “embossing” is a process to provide a surface of the product with fine patterned irregular texture. As an example, an example of the outer blade 22 of the fifth example is illustrated in an enlarged view in FIG. 21 (a drawing of a position equivalent to that in FIG. 17). As illustrated in FIG. 21, multiple fine projections (convex portions) 29 projecting in the axial direction (direction indicated by an arrow B) are provided on the surfaces of annular shaving surfaces 22A and 22B. As a modification, a configuration in which multiple depressions (concave portions) depressed in the axial direction are also provided on the surface of the annular shaving surface is conceivable (not illustrated).

Here, the shape of the projections 29 is not specifically limited, and may be formed into a shape such as a semispherical shape, a conical shape having a rounded tip, and a cylindrical shape rounded at an entire distal end or an outer edge of the distal end, for example. The height of the projections 29 (an axial size, that is, the size in the vertical direction) is not specifically limited. However, it is preferably smaller than the thickness of the outer blade 22 (the thickness in the axial direction, that is, the thickness in the vertical direction), in particular, smaller than the thickness of the rib portions 27 (the thickness in the axial direction, that is, the thickness in the vertical direction). As an example, the projections 29 are formed to have a thickness 0.5 μm to approximately three-tenth, inclusive, of the thickness of the rib portion 27. The number of the projections 29 is not also specifically limited, and preferably is the same as or more than the number of the hair inlets 23. As an example, the number of the projections 29 is set to a number not smaller than approximately five times the number of the hair inlets 23 provided on the annular shaving surfaces 22A and 22B.

As described above, with the configuration in which the front surfaces of the annular shaving surfaces 22A and 22B are embossed, the contact surface area with respect to the skin decreases, and thus the sliding resistance is lowered. Therefore, when moving the outer blade so as to slide along the skin, the outer blade slides smoothly, so that the user can get a smooth feeling of use. In particular, with the configuration in which the multiple fine projections (convex portions) 29 projecting in the axial direction are provided as an example of the embossing, the contact surface area with respect to the skin can be decreased significantly compared with the configuration provided with the same number of concave portion, and thus further enhancement of the advantageous effects of achieving smooth sliding is achieved.

In contrast, the outer blade 122 of the related art illustrated in FIG. 9 and FIG. 12 is formed by press work using the thin flat plate material made of stainless steel alloy as described above. Therefore, when an attempt is made to emboss the surface of the annular shaving surface 122A, processing by sandblast or etching is conceivable. However, there are the following problems. In other words, with the sandblast process, the depressions (concave portions) can be formed on the front surface of the annular shaving surface 122A, but the projections (convex portions) cannot be formed. In addition, forming the projections (convex portions) similar to the fifth example on the surface of the annular shaving surface 122A by etching process is impossible or difficult to realize in view of a processing method or the time required for work in the high-volume production property of the industrial products. Therefore, it may be said that embossing the annular shaving surface which achieves smooth sliding on the skin as in the fifth example is impossible or difficult with the outer blade 122 formed of the metal material of the related art.

In this manner, according to the outer blade 22 of the fifth example, the outer blade is formed by injection molding or compression molding using a resin material. Therefore, the shapes exemplified in FIG. 21 described above, which is impossible to form by a technology in the related art, can be realized.

### SIXTH EXAMPLE

Subsequently, the outer blade 22 of a sixth example will be described. The outer blade 22 according to the sixth example includes an integral structure using a resin material in the same manner as those of the first to fifth examples described above. Other configurations may be the same as those of the first to fifth examples, or may be different. Characteristic configurations of the sixth example will be focused in description given below.

The outer blade 22 according to the sixth example is formed by using a material having transparency or translucency as the resin material thereof. As used herein, the term “transparent” means a state in which light transmissibility is quite high and thus the other side can be seen through, and the term “having translucency” means a state in which light to be transmitted therethrough is diffused, or the transmission factor is low, and thus the shape on the other side cannot be recognized clearly or cannot be recognized at all.

According to this configuration, by using a transparent material unlike the outer blade 122 using a metal material that does not have light transmissivity as in the related art, a so-called skeleton structure through which the inner blade 40 or the like which is disposed in the interior of the outer blade 22 is visible is realized. Therefore, an innovative design with high customer-appealing power, which cannot be found in the related art, can be realized. With the configuration in which the portion of the inner blade 40 is visible, an effect of clearly notifying timing for cleaning the inner blade 40 is also achieved. In contrast, if a problem occurs in that the user worries dirtiness in the interior because the portion of the inner blade 40 is excessively visible, the transmission factor may be set as desired by using the material having the translucency. Therefore, the outer blade 22 having a permeability (translucency) to an extent that prevents the inner blade 40 to be excessively visible can be formed.

Here a resin material to be used for forming the outer blade 22 may contain a colorant that gives a color thereto. Therefore, the transparent material or a material which has translucency described above may have a configuration including the colorant, or may have a configuration in which an opaque (having no translucency) material contains the colorant.

The outer blade 122 of the related art is formed through the press work, the polishing work, or the like by using the thin flat plate material made of stainless steel alloy as described before, and thus can be mirror-finished depending on the extent of polishing. Anyway, however, the surface has a metallic color (metallic gross color). Therefore, when an attempt is made to color the outer blade 22, a method of coloring using paint or pigment, or a method of forming an oxide film and causing the film to produce color is inevitably employed. In this case, since a post process such as a paint/pigment application/coloring work, or a color-creating work by forming an oxide film is required, an increase in both of the number of working steps and the time required for work and hence an increase in manufacturing costs may result. In addition, in the case of the method of coloring by using a paint or a pigment, there may arise a problem of peel-off of the paint or the pigment as it is used.

In contrast, according to the outer blade 22 of the sixth example, the outer blade 22 having a predetermined color is formed at the time of molding by carrying out the injection molding and the compression molding with a resin material containing a colorant. Consequently, the post process for coloring is not necessary. Therefore, a step of forming the outer blade 22 which is to be colored is greatly simplified compared with the related art. In addition, the problem of peel-off of the paint and the pigment never occurs.

Furthermore, a resin material having multiple colors may be used as the resin material which constitutes the outer blade 22. In other words, the outer blade 22 can be formed by using multiple types of resin materials having different colors from each other. In this case, the expression “multiple types of resin materials having different colors from each other” includes materials having transparency and translucency, which may be selected as a component.

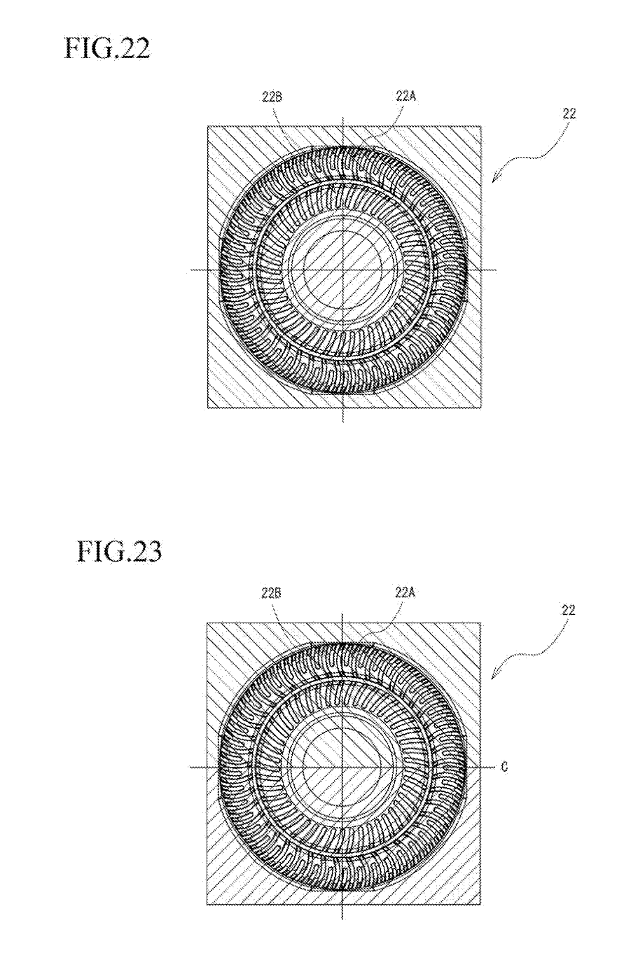

Therefore, by using, for example, the processing method for forming multiple layers which is represented by two-color molding, the outer blade 22 provided with the multiple annular shaving surfaces having different colors (including transparent and the like) may be formed. As an example, a configuration provided with the annular shaving surfaces 22A and 22B having different colors from each other may be employed as illustrated in FIG. 22 (that is, a portion included in a hatching area sloping downward to the right and a portion included in a hatching area sloping downward to the left in FIG. 22 have different colors). As an alternative example, a configuration in which the annular shaving surfaces 22A and 22b are equally divided (equally divided into two parts in this case) at a center position (centerline C) and each of these parts has different color as illustrated in FIG. 23 (that is, a portion included in a hatching area sloping downward to the right and a portion included in a hatching area sloping downward to the left in FIG. 23 have different colors) is also conceivable. As a matter of course, these configurations are only part of the configuration examples, and other various configurations may be employed.

The outer blade 122 of the related art is formed by using the thin flat plate material made of stainless steel alloy as described above, and thus can be colored by a method using a paint or the like. However, the outer blade 122 formed of a colored metal material and the outer blade 22 molded with a resin material containing a colorant as in the sixth example are significantly different in texture. In particular, a light-weight impression provided by the resin material having a color cannot be obtained by the configuration in which the metal material is colored. In this manner, according to the sixth example, an innovative design with high customer-appealing power, which cannot be found in the related art, can be realized. In addition, in contrast to the method of coloring by applying paint which may result in significant degradation of texture if the paint is peeled off, the resin material containing a colorant does not have such a risk at all.

In this manner, according to the outer blade 22 of sixth example, the outer blade is formed by injection molding or compression molding using a resin material. Therefore, designs and textures, which cannot be achieved with the outer blade formed of the metal material of the related art, can be realized.

### SEVENTH EXAMPLE

Subsequently, the outer blade 22 of a seventh example will be described. The outer blade 22 according to the seventh example includes an integral structure using a resin material in the same manner as those of the first to sixth examples described above. Other configurations may be the same as those of the first to sixth examples, or may be different. Characteristic configurations of the seventh example will be focused in description given below.

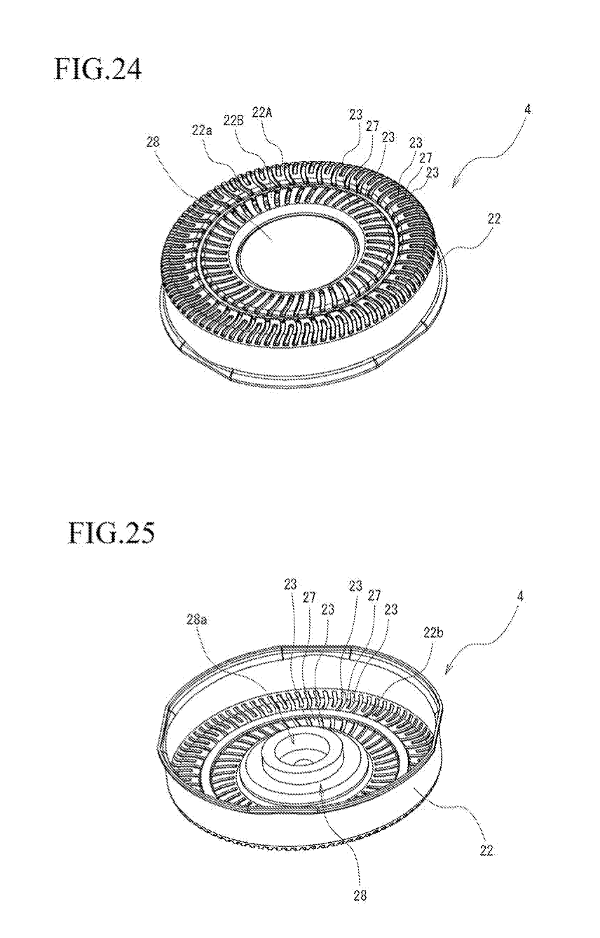

FIG. 24 is an upper surface side perspective view (schematic view) of the outer blade 22 according to the seventh example, and FIG. 25 is a lower surface side perspective view (schematic view) of the same. The first example described above is an example of the outer blade assembly 4 including the outer blade 22 and the outer blade cover 25 which is to be fitted thereto. In contrast, the seventh example is an example of the outer blade assembly 4 including a single component, that is, only the outer blade 22 having an integral structure including a shape corresponding to the outer blade cover.

More specifically, the outer blade 22 according to the seventh example includes a fixing portion 28 that fixes the inner blade 40 so as to be movable in the axial direction and immovable in the radial direction formed into the integral structure at a center position of the lower surface 22b in the radial direction as illustrated in FIG. 24 and FIG. 25. For example, the fixing portion 28 is provided with a cylindrical portion 28a extending downward (downward in the axial direction) from the lower surface 22b of the outer blade 22. In this configuration, the center of the outer blade 22 (the annular shaving surfaces 22A and 22B) matches a center of the cylindrical portion 28a. A convex portion 44b of the inner blade base 44 which fixes the inner blade 40 from below engages (fits in) the cylindrical portion 28a. In this case, in a state where the center of the inner blade 40 is aligned with the center of the outer blade 22, both of these are restrained from moving (positioned) in the radial direction. In this state, the inner blade 40 is rotatable with respect to the outer blade 22, and is movable in the vertical direction.

The outer blade assembly of the related art includes at least two components, that is, the outer blade 122 formed of a metal material and the outer blade cover (not illustrated) formed by using a resin material fitted to the central portion of the outer blade 122. In contrast, the outer blade 22 having an integral structure including the shape corresponding to the outer blade cover can be formed by using the resin material in the seventh example, and thus the outer blade assembly 4 including only a single component can be realized. Therefore, the number of components can be half decreased, and it is possible to eliminate a process for assembling the multiple components and assembly equipment required for the process. Therefore, it is possible to greatly decrease component costs and assembly costs.

As described thus far, with the rotary electric shaver and the method of manufacturing the outer blade of the rotary electric shaver of the present invention, structures, designs, and textures which have been impossible or difficult to achieve with the outer blade of the related art formed of a metal material can be realized with the outer blade formed of the injection molding or the compression molding using a resin material. In addition, reduction in manufacturing costs of the outer blade is achieved.

The present invention is not limited to the examples described above and may be modified variously without departing from the scope of the present invention. In particular, an example has been described in which the rotary electric shaver has three sets of the dual track structure combination of the outer blade and the inner blade (blade unit). However, the present invention is not limited thereto.

What is claimed is:

1. A rotary electric shaver comprising:
an outer blade including an annular shaving surface provided with multiple hair inlets formed therein on an upper surface thereof; and
an inner blade having a small blade which rotates in sliding contact with a lower surface of the outer blade from below the annular shaving surface,
wherein the outer blade has an integral structure using a resin material, and has a rib portion which is located between adjacent hair inlets.

2. The rotary electric shaver according to claim 1,
wherein the outer blade includes multiple types of rib portions different in height position of an upper surface as the rib portion.

3. The rotary electric shaver according to claim 2,
wherein the rib portion having the lowest height position out of the rib portions is formed to have a length in a height direction of approximately three-tenths to approximately nine-tenths, inclusive, of the rib portion having the highest height position.

4. The rotary electric shaver according to claim 1,
wherein the outer blade includes the rib portion having an upper surface formed into one of convex, concave, and waving shapes along a radial direction.

5. The rotary electric shaver according to claim 1,
wherein the outer blade includes the rib portion having the upper surface formed into a curved shape at both end portions in the circumferential direction.

6. The rotary electric shaver according to claim 1,
wherein the outer blade includes the rib portion with the upper surface formed into a convex curved shape along the circumferential direction.

7. The rotary electric shaver according to claim 1,
wherein the outer blade includes the rib portion having a lower surface, the lower surface includes a rear side in a rotation direction of the inner blade and a front side in the rotation direction of the inner blade, and the rear side is formed at a relatively low position that comes into sliding contact with the inner blade and the front side is formed at a relatively high position that does not come into sliding contact with the inner blade.

8. The rotary electric shaver according to claim 1,
wherein the outer blade includes the annular shaving surface having an embossed front surface.

9. The rotary electric shaver according to claim 1,
wherein the outer blade includes multiple projections projecting in an axial direction on a surface of the annular shaving surface.

10. The rotary electric shaver according to claim 9,
wherein the height of the projections is smaller than the thickness of the outer blade.

11. The rotary electric shaver according to claim 1,
wherein the resin material is an engineering plastic having a Rockwell Hardness HRC 40-60.

12. The rotary electric shaver according to claim 1,
wherein the resin material is a material having transparency or translucency.

13. The rotary electric shaver according to claim 1,
wherein the resin material contains a colorant that gives a color thereto.

14. The rotary electric shaver according to claim 1,
wherein the outer blade is formed of the resin material having multiple colors.

15. The rotary electric shaver according to claim 1,
wherein the outer blade includes the multiple annular shaving surfaces having different colors.

16. The rotary electric shaver according to claim 1,
wherein the outer blade includes a fixing portion formed at a center position of the lower surface in the radial direction as an integral structure, and the fixing portion fixes the inner blade so as to be movable in the axial direction and immovable in the radial direction.

17. The rotary electric shaver according to claim 16,
wherein the fixing portion includes a cylindrical portion that extends downward from the lower surface of the outer blade.

18. A method of manufacturing an outer blade of a rotary electric shaver comprising: an outer blade including an annular shaving surface provided with multiple hair inlets formed therein on an upper surface thereof; and an inner blade having a small blade which rotates in sliding contact with a lower surface of the outer blade from below the annular shaving surfaces, the method comprising:
a step of forming the outer blade as an integral structure by injection molding or compression molding using a resin material.
